(19) United States
(12) Patent Application Publication
(10) Pub. No.: US 2026/0036369 A1
(43) Pub. Date: Feb. 5, 2026

(54) METHOD FOR MANUFACTURING POROUS BODY AND POROUS BODY

(71) Applicant: FUJIFILM Corporation, Tokyo (JP)

(72) Inventor: Daigo SAWAKI, Minamiashigara-shi (JP)

(73) Assignee: FUJIFILM Corporation, Tokyo (JP)

(21) Appl. No.: 19/358,470

(22) Filed: Oct. 15, 2025

Related U.S. Application Data
(63) Continuation of application No. PCT/JP2024/013584, filed on Apr. 2, 2024.

(30) Foreign Application Priority Data
Apr. 20, 2023 (JP) 2023-069111

(51) Int. Cl. F26B 21/10; B29C 71/02; F26B 3/347; F26B 21/08

(52) U.S. Cl. CPC F26B 21/10; B29C 71/02; F26B 3/347; F26B 21/08

(57) ABSTRACT

An object of the present invention is to provide a method for manufacturing a porous body, the method making it possible to suppress volume shrinkage during drying at a pressure of 10² Pa or more and 10⁶ Pa or less, and to obtain a porous body with a high porosity; and a porous body. The present invention is a method for manufacturing a porous body, the method including subjecting a gel that has a solvent including water and a structure body with a three-dimensional mesh structure to a drying treatment to produce a porous body, in which the drying treatment is carried out at a pressure of 10² Pa or more and 10⁶ Pa or less and a temperature equal to or higher than a boiling point of the solvent such that an internal temperature of the gel is equal to or higher than an external temperature of the gel.

### CROSS-REFERENCE TO RELATED APPLICATIONS

This application is a Continuation of PCT International Application No. PCT/JP2024/013584, filed on Apr. 2, 2024, which claims priority under 35 U.S.C. § 119 (a) to Japanese Patent Application No. 2023-069111, filed on Apr. 20, 2023. The above applications are hereby expressly incorporated by reference, in their entirety, into the present application.

### BACKGROUND OF THE INVENTION

### 1. Field of the Invention

The present invention relates to a method for manufacturing a porous body and a porous body.

### 2. Description of the Related Art

A porous body obtained by drying a dispersion of a structure body with a three-dimensional mesh structure, such as cellulose nanofibers, has a high porosity, thus has heat insulating performance equivalent to that of air, and is expected to be applied to various uses.

As a method for manufacturing a porous body, for example, a method in which hydrogel including a structure body with a three-dimensional mesh structure is subjected to supercritical drying or the like ([claim 1], [claim 3], [claim 8], [claim 11], and [claim 12]) is described in JP2022-148855A.

### SUMMARY OF THE INVENTION

The present inventors have found that the method using supercritical drying described in JP2022-148855A is not suitable for manufacturing, and thus, in a case where drying is attempted at a pressure of 10² Pa or more and 10⁶ Pa or less, volume shrinkage occurs and the porosity is significantly reduced.

Therefore, an object of the present invention is to provide a method for manufacturing a porous body, the method making it possible to suppress volume shrinkage during drying at a pressure of 10² Pa or more and 10⁶ Pa or less, and to obtain a porous body with a high porosity; and a porous body.

As a result of intensive studies to achieve the object, the present inventors have found that by subjecting a gel that has a solvent including water and a structure body with a three-dimensional mesh structure to a specific drying treatment at a pressure of 10² Pa or more and 10⁶ Pa or less, it is possible to suppress volume shrinkage, and to obtain a porous body with a high porosity, thereby completing the present invention.

That is, the present inventors have found that the object can be accomplished by the following configurations.

[1] A method for manufacturing a porous body, the method including:
subjecting a gel that has a solvent including water and a structure body with a three-dimensional mesh structure to a drying treatment to produce a porous body,
in which the drying treatment is carried out at a pressure of 10² Pa or more and 10⁶ Pa or less and a temperature equal to or higher than a boiling point of the solvent such that an internal temperature of the gel is equal to or higher than an external temperature of the gel.

[2] The method for manufacturing a porous body according to [1],
in which the structure body with a three-dimensional mesh structure is a cellulose nanofiber.

[3] The method for manufacturing a porous body according to [1] or [2],
in which a temperature difference between the internal temperature of the gel and the external temperature of the gel is 50° C. or less.

[4] The method for manufacturing a porous body according to any one of [1] to [3],
in which a shape of the gel is a three-dimensional shape which may have a curved surface, and
a surface area of one surface X is equal to or more than a total surface area of surfaces adjacent to the surface X.

[5] The method for manufacturing a porous body according to any one of [1] to [4],
in which the drying treatment is a treatment of carrying out at least one of superheated steam drying or microwave drying.

[6] A method for manufacturing a porous body, the method including:
subjecting a gel that has a solvent including water and a structure body with a three-dimensional mesh structure to a drying treatment to produce a porous body,
in which the drying treatment is a treatment where at least one of superheated steam drying or microwave drying is carried out at a pressure of 10² Pa or more and 10⁶ Pa or less and a temperature equal to or higher than a boiling point of the solvent.

[7] The method for manufacturing a porous body according to [6],
in which the structure body with a three-dimensional mesh structure is a cellulose nanofiber.

[8] A porous body having a porosity of 80% or more, the porous body including:
a layered structure in a plane direction.

[9] The porous body according to [8],
in which an indentation fracture stress is 0.5 MPa or more.

According to the present invention, it is possible to provide a method for manufacturing a porous body, the method making it possible to suppress volume shrinkage during drying at a pressure of 10² Pa or more and 10⁶ Pa or less, and to obtain a porous body with a high porosity; and a porous body.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

Furthermore, any numerical range expressed using “to” in the present specification refers to a range including the numerical values before and after the “to” as a lower limit value and an upper limit value, respectively.

In addition, in the present specification, an upper limit value or a lower limit value described in a certain numerical range in a numerical range described in a stepwise manner may be replaced with an upper limit value or a lower limit value in another numerical range described in a stepwise manner. Moreover, regarding the numerical range described in the present specification, an upper limit value or a lower limit value described in a numerical range may be replaced with a value described in Examples.

In addition, in the present specification, substances corresponding to respective components may be used alone or in combination of two or more kinds thereof. Here, in a case where two or more kinds of substances are used in combination for each component, the content of the component indicates the total content of the substances used in combination, unless otherwise specified.

### [Method for Manufacturing Porous Body]

The methods for manufacturing a porous body according to a first aspect and a second aspect of the present invention (hereinafter also referred to as “the manufacturing method according to the embodiment of the present invention” in a case where a particular distinction is not required) are each a method for manufacturing a porous body, the method including subjecting a gel that has a solvent including water and a structure body with a three-dimensional mesh structure (the gel being hereinafter also referred to as “a structure body hydrogel”) to a drying treatment to produce a porous body.

In addition, in the method for manufacturing a porous body according to the first aspect of the present invention (hereinafter also referred to as “the first manufacturing method of the embodiment of the present invention”), the drying treatment is carried out at a pressure of 10² Pa or more and 10⁶ Pa or less and a temperature equal to or higher than the boiling point of the solvent such that the internal temperature of the gel is equal to or higher than the external temperature of the gel.

Moreover, in the method for manufacturing a porous body according to the second aspect of the present invention (hereinafter also referred to as “the second manufacturing method of the embodiment of the present invention”), the drying treatment is carried out by at least one of superheated steam drying or microwave drying at a pressure of 10² Pa or more and 10⁶ Pa or less and a temperature equal to or higher than the boiling point of the solvent.

Furthermore, the boiling point of the solvent in the manufacturing method of the embodiment of the present invention refers to the boiling point of the solvent at normal pressure.

In the manufacturing method of the embodiment of the present invention, in the first aspect, by carrying out the drying treatment at a pressure of 10² Pa or more and 10⁶ Pa or less and a temperature equal to or higher than the boiling point of the solvent such that the internal temperature of the gel is equal to or higher than the external temperature of the gel; and in the second aspect, by carrying out the drying treatment by at least one of superheated steam drying or microwave drying at a pressure of 10² Pa or more and 10⁶ Pa or less and a temperature equal to or higher than the boiling point of the solvent, it is possible to suppress the volume shrinkage during drying at a pressure of 10² Pa or more and 10⁶ Pa or less, and to obtain a porous body with a high porosity.

A reason why the effect is expressed is not specifically clear, but is presumed to be as follows by the present inventors.

First, the present inventors speculate that in the drying treatment at a pressure of 10² Pa or more and 10⁶ Pa or less, in a case where the moisture in the gel is dried, the capillary force of water is generated with the movement of the moisture in the gel (for example, movement from the inside of the cube to the side surface direction), and the volume shrinkage occurs during the drying due to the capillary force.

Therefore, in the manufacturing method of the embodiment of the present invention, it is considered that an expansion pressure is generated inside the gel by carrying out the above-described drying treatment, which can offset the capillary force of water associated with the movement of moisture, whereby the volume shrinkage during drying at a pressure of 10² Pa or more and 10⁶ Pa or less can be suppressed.

Hereinafter, the structure body hydrogel and the drying treatment used in the manufacturing method of the embodiment of the present invention will be described in detail.

### [Structure Body Hydrogel]

The structure body hydrogel used in the manufacturing method of the embodiment of the present invention is a gel that has a solvent including water and a structure body with a three-dimensional mesh structure, and serves as an object to be subjected to a drying treatment which will be described later.

### <Solvent>

The solvent contained in the structure body hydrogel is not particularly limited as long as it includes at least water, and may be only water or may be a mixed solvent of water and an organic solvent.

Here, examples of the organic solvent include:
ester-based solvents such as ethyl acetate, butyl acetate, isopropyl acetate, ethylene glycol monoethyl ether acetate, propylene glycol monomethyl ether acetate, and propylene glycol monoethyl ether acetate;
ether-based solvents such as propylene glycol monomethyl ether, ethylene glycol monomethyl ether, ethylene glycol isopropyl ether, ethylene glycol t-butyl ether, ethylene glycol monoethyl ether, ethylene glycol monobutyl ether (butyl cellosolve), and propylene glycol monobutyl ether;
alcohol-based solvents such as methanol, ethanol, ethoxypropanol, butanol, methoxybutanol, methylmethoxybutanol, propyl alcohol, and 2-ethylhexanol;
ketone-based solvents such as acetone, methyl ethyl ketone, and methyl isobutyl ketone;
aliphatic hydrocarbon-based solvents such as WASOL, SHELLSOL, and mineral spirits;
aromatic solvents such as xylene and toluene; and
aprotic polar solvents such as acetonitrile and dimethyl sulfoxide, and
these may be used alone or in combination of two or more kinds thereof.
   <Structure Body with Three-Dimensional Mesh Structure>

The structure body with a three-dimensional mesh structure, which is contained in the structure body hydrogel, refers to a structure in which materials constituting the structure body are three-dimensionally connected to each other to form an integrally continuous network.

In addition, examples of the structure body with a three-dimensional mesh structure, which is contained in the structure body hydrogel, include at least one selected from the group consisting of cellulose nanofibers, cellulose derivatives, chitosan, chitin nanofibers, alginic acid, hyaluronic acid, pectin, carrageenan, gellan gum, xanthan gum, nanoporous ceramics (for example, silica and zinc oxide), derivatives thereof, and combinations thereof.

Among these, the cellulose nanofibers (hereinafter also referred to as “CNF”) are preferable.

The cellulose nanofibers are not particularly limited as long as they are a material obtained from a cellulose-based raw material.

The cellulose-based raw material is not particularly limited as long as it is a material mainly containing cellulose, and examples thereof include pulp, natural cellulose, regenerated cellulose, and microcrystalline cellulose obtained by depolymerizing a cellulose raw material by performing a mechanical treatment. Furthermore, as the cellulose-based raw material, a commercially available product such as crystalline cellulose using pulp as a raw material can be used as it is. The cellulose-based raw material may be subjected to a chemical treatment such as an alkali treatment to facilitate the permeation of an oxidizing agent.

The fiber length of the cellulose nanofiber is not particularly limited, but is preferably 100 nm to 5,000 nm, more preferably 50 nm to 2,000 nm, and still more preferably 100 nm to 700 nm.

In addition, the fiber diameter of the cellulose nanofiber is not particularly limited, but is preferably 1 nm to 100 nm, and more preferably 2 nm to 10 nm.

A method for obtaining cellulose nanofibers from a cellulose-based raw material is not particularly limited, and a known method in the technical field of the present invention can be used. For example, cellulose nanofibers can be manufactured by a method of subjecting a cellulose-based raw material to an oxidation treatment with sodium hypochlorite, which is an oxidizing agent, in the presence of a compound having a piperidine skeleton, such as 2,2,6,6-tetramethyl-1-piperidine-N-oxyl radical (hereinafter abbreviated as “TEMPO”) as a catalyst.

### <Method for Producing Gel>

The method for producing the structure body hydrogel is not particularly limited, and examples thereof include a method in which a gelling agent is added to the above-described solution containing the solvent and the structure body with a three-dimensional mesh structure.

In addition, the solution may be concentrated before the addition of the gelling agent, as necessary.

As the gelling agent, for example, an acidic solution, a basic solution, or a metal salt solution can be used.

Examples of the acidic solution include a solution at a concentration in a range of 0.1 M to 1 M, which includes phosphoric acid, sulfuric acid, hydrochloric acid, acetic acid, citric acid, lactic acid, and the like.

Examples of the basic solution include a solution at a concentration in a range of 0.1 M to 1 M, which includes sodium hydroxide, ammonia, urea, tetramethylammonium hydroxide, and the like.

As the metal salt solution, for example, a solution including a polyvalent metal salt, and preferably a divalent metal salt can be used. Specific examples of such a metal salt include an Al salt, an Fe salt, a Ca salt, and an Mg salt. In addition, the concentration of the metal salt can be appropriately set, but is typically in a range of 0.1 M to 1 M.

In a case of concentrating the above-described solution containing the solvent and the structure body with a three-dimensional mesh structure before adding the gelling agent, the concentration method is not particularly limited, but preferably includes a step of concentrating the solution under the conditions of a temperature of 20° C. to 80° C. and a humidity of 50% to 90%.

In the manufacturing method of the embodiment of the present invention, from the reason that it is possible to further suppress the volume shrinkage during drying at a pressure of 10² Pa or more and 10⁶ Pa or less, and to obtain a porous body having a higher porosity, it is preferable that the shape of the structure body hydrogel is a three-dimensional shape which may have a curved surface, and the shape is such that a surface area of one surface X is equal to or more than the total surface area of the surfaces adjacent to the surface X.

For example, in a case where the shape of the structure body hydrogel is a polyhedron shape including a top surface part, a bottom surface part, and side surface parts, the top surface part corresponds to the surface X, and most of the moisture inside the gel moves in the direction of the surface X during drying at a pressure of 10² Pa or more and 10⁶ Pa or less. Therefore, the capillary force of water generated at that time is perpendicular to the movement direction of the moisture (that is, the direction from the side surface to the inside). Therefore, the present inventors speculate that in a case where the shape of the structure body hydrogel is a polyhedron shape including a top surface part, a bottom surface part, and side surface parts, the top surface part corresponds to the surface X, and the capillary force of water is parallel to the bottom surface part and is weakened by an anchor effect of the gel itself, and therefore, it is possible to further suppress the volume shrinkage during drying at a pressure of 10² Pa or more and 10⁶ Pa or less, and to obtain a porous body having a higher porosity.

### [Drying Treatment (First Aspect)]

The drying treatment in the first manufacturing method of the embodiment of the present invention is carried out at a pressure of 10² Pa or more and 10⁶ Pa or less and a temperature equal to or higher than the boiling point of the solvent such that the internal temperature of the gel is equal to or higher than the external temperature of the gel. In the first manufacturing method of the embodiment of the present invention, it is considered that an expansion pressure is generated inside the gel by carrying out a drying treatment such that the internal temperature of the gel is equal to or higher than the external temperature of the gel.

Here, the internal temperature of the gel refers to the internal temperature of the structure body hydrogel, but in the first manufacturing method of the embodiment of the present invention, it can be directly confirmed by a thermocouple.

In addition, the external temperature of the gel refers to the external temperature of the structure body hydrogel, but in the first manufacturing method of the embodiment of the present invention, it can be directly confirmed by a thermocouple.

In the first manufacturing method of the embodiment of the present invention, from the reason that a porous body having a higher porosity can be obtained, the pressure of the drying treatment is preferably 10³ Pa or more and 10⁵ Pa or less, and more preferably 10⁴ Pa or more and 10⁵ Pa or less.

Moreover, in the first manufacturing method of the embodiment of the present invention, the temperature of the drying treatment (hereinafter also referred to as a “drying temperature”) is not particularly limited as long as it is a temperature equal to or higher than the boiling point of the above-described solvent, but is preferably 100° C. to 200° C., and more preferably 100° C. to 180° C.

Furthermore, the internal temperature of the structure body hydrogel is not particularly limited as long as it is equal to or higher than the external temperature of the structure body hydrogel, but is preferably 100° C. to 200° C., and more preferably 100° C. to 180° C.

In addition, the external temperature of the structure body hydrogel is not particularly limited as long as it is equal to or lower than the internal temperature of the structure body hydrogel, but is preferably 100° C. to 200° C., and more preferably 100° C. to 180° C.

Moreover, in the first manufacturing method of the embodiment of the present invention, from the reason that the expansion and the rupture of the structure body hydrogel can be suppressed, the temperature difference between the internal temperature of the gel and the external temperature of the gel in the drying treatment is preferably 50° C. or less, more preferably 10° C. to 50° C., and still more preferably 20° C. to 40° C.

Furthermore, in the first manufacturing method of the embodiment of the present invention, from the reason that it is easy to adjust the internal temperature of the gel to be equal to or higher than the external temperature of the gel, the drying treatment is preferably a treatment of carrying out at least one of superheated steam drying or microwave drying, and more preferably a treatment of carrying out superheated steam drying.

Here, the superheated steam drying is a method in which drying is performed using vapor of a solvent that has been superheated to a temperature equal to or higher than a saturation temperature. However, since the solvent contained in the structure body hydrogel includes at least water, for example, a method in which drying is performed using a superheated steam dryer set at a temperature of 100° C. to 180° C. and a humidity of 10% to 50% is preferable.

In addition, the microwave drying is a drying method in which molecules of a solvent are vibrated by microwaves to generate heat and evaporate the solvent. However, from the viewpoint of suppressing the expansion and the rupture of the structure body hydrogel, for example, a method in which drying is performed under conditions of a wavelength of 1 mm to 10 cm and an output of 1 to 5 kW is preferable.

### [Drying Treatment (Second Aspect)]

The drying treatment in the second manufacturing method of the embodiment of the present invention is a treatment in which at least one of superheated steam drying or microwave drying is carried out at a pressure of 10² Pa or more and 10⁶ Pa or less and a temperature equal to or higher than the boiling point of the solvent, and is preferably the treatment in which the superheated steam drying is carried out.

In the second manufacturing method of the embodiment of the present invention, the temperature condition of the drying treatment is not particularly limited as long as it is a temperature equal to or higher than the boiling point of the above-described solvent, but is preferably 100° C. to 200° C., and more preferably 100° C. to 180° C.

Furthermore, the pressure for the drying treatment in the second manufacturing method of the embodiment of the present invention, and the superheated steam drying or the microwave drying used in the drying treatment are the same as those described as the suitable aspect of the first manufacturing method of the embodiment of the present invention.

### [Porous Body]

The porous body of the embodiment of the present invention is a porous body having a porosity of 80% or more, the porous body including a layered structure in a plane direction.

Here, the “porosity” refers to a value measured by the following procedure. First, a volume V and a mass W of the porous body are measured. Next, a density D of the structure body with a three-dimensional mesh structure, which constitutes the porous body, is set to 1.5 g/cm³. Next, the porosity is calculated from the following expression.

Porosity=100×{Volume V−(Mass W/Density D)}/Volume V

In addition, the expression “having a layered structure in a plane direction” means having a structure in which a plurality of structures aligned in parallel with the surface of the porous body are stacked.

From the viewpoint of processing suitability, the indentation fracture stress of the porous body of the embodiment of the present invention is preferably 0.5 MPa or more, and more preferably 1 MPa or more and 5,000 MPa or less.

Here, the indentation fracture stress refers to a value measured under the following conditions. Furthermore, the measurement is performed under the following conditions, and a point where the stress does not increase or decreases with respect to the applied strain is calculated as the breaking stress.
Device: Micro Autograph MST manufactured by Shimadzu Corporation
Load cell: 2 N Max
Indenter: Custom-made plastic indenter having a diameter of 15 mmΦ
Sample size: 10 mm square
Compression speed: 100%/min (10 mm/min)
Number of n: 3
Compression elastic modulus: Calculated from strain of 0% to 1%

From the viewpoint of processing suitability, the interlayer distance of the porous body of the embodiment of the present invention is preferably at least 1 nm or more and 10 μm or less, more preferably 5 nm or more and 5 μm or less, and still more preferably 5 nm or more and 1 μm or less. In a case where the distance is 10 μm or less, the porous body is durable against pressure such as a finger during processing, and in a case where the distance is 1 nm or more, it is easy to adjust the porosity to 80% or more.

### Use

The porous body produced by the manufacturing method of the embodiment of the present invention or the porous body of the embodiment of the present invention can be used for various applications, and can be suitably used, for example, for a window or a member thereof. Specifically, the porous body can be suitably used for an interlayer film of laminated glass, an interlayer film of multilayer glass, or the like.

Furthermore, for the laminated glass and the multilayer glass, a known configuration in the related art can be adopted for the number and the type of glass plates, layers other than the glass plates and the interlayer film (for example, a light shielding layer, a heat shielding layer, and a flame retardant layer), a sealing structure, and the like.

### EXAMPLES

Hereinbelow, the present invention will be described in more detail with reference to Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be interpreted in a limited manner by the following Examples.

### Example 1

### [Production of Cellulose Nanofibers]

10 g of coniferous wood kraft pulp was suspended in 1,000 g of pure water in which 0.16 g of TEMPO and 1 g of sodium bromide were dissolved. 25 g of an aqueous sodium hypochlorite solution having an effective chlorine amount of 2 M was added thereto to initiate an oxidation reaction. The temperature in the reaction system was kept at 25° C., and during the reaction, the pH in the system was kept at 10 during the reaction by adding a 0.5 M aqueous sodium hydroxide solution thereto. After 2 hours had elapsed, about 100 mL of ethanol was added to the reaction system to terminate the oxidation reaction. Thereafter, the filtration washing was repeatedly performed using a glass filter and pure water to obtain oxidized cellulose. The obtained cellulose oxide was passed through a high-pressure homogenizer three times to prepare a dispersion including 1% by mass of cellulose nanofibers. The obtained cellulose nanofibers had a carboxy group content of 1.5 mmol/g, a fiber diameter of 3 nm, and a fiber length of 500 nm.

### [Concentration of Dispersion]

The aqueous cellulose nanofiber (CNF) dispersion obtained above was kept in a constant-temperature and constant-humidity dryer for 8 to 10 days under the conditions of a temperature of 40° C. and a humidity of 80% to prepare a concentrated dispersion having a CNF concentration of 4% by weight. It was confirmed that the concentrated dispersion has an alignment degree of 78% to 83% and has structural anisotropy.

### [Production of Structure Body Hydrogel]

An HCl solution (1 M) as a gelling agent was added to the CNF concentrated dispersion obtained above to cause gelation. Furthermore, the gelation was performed in a petri dish having a diameter of 15 cm such that the thickness of the gel was 1 cm.

After the gelation, a hexahedral shape having a length of 10 mm×a width of 10 mm×a thickness of 10 mm was cut out to produce a structure body hydrogel (CNF concentration: about 4% by mass, solvent: water).

### [Production of Porous Body (Drying Treatment)]

The structure body hydrogel obtained above was put into a superheated steam dryer set at a temperature of 100° C. and a humidity of 50%, and allowed to stand for a predetermined drying time to obtain a porous body.

Furthermore, the drying time was estimated from values from a graph produced with the drying time versus the mass change.

In addition, the pressure, the drying temperature, the internal temperature of the gel, the external temperature of the gel, the area of the top surface part of the gel, and the total area of the side surface parts of the gel are shown in Table 1 below.

### Example 2

A porous body was produced by the same method as in Example 1, except that the size of the hexahedral shape to be cut out after gelation was changed to a length of 36 mm× a width of 45 mm×a thickness of 10 mm.

### Example 3

A porous body was produced by the same method as in Example 1, except that the size of the hexahedral shape to be cut out after gelation was changed to a length of 100 mm×a width of 100 mm×a thickness of 10 mm.

### Example 4

A porous body was produced by the same method as in Example 3, except that the drying temperature, the internal temperature of the gel, and the external temperature of the gel were changed to the values shown in Table 1 below.

### Example 5

A porous body was produced by the same method as in Example 3, except that the solvent was changed from water to “water containing 10% of ethanol”.

### Example 6

A porous body was produced by the same method as in Example 3, except that microwave drying described below was performed instead of the drying treatment using the superheated steam dryer.

That is, the structure body hydrogel produced by the same method as in Example 3 was put into a microwave dryer. As the microwave output, an output value such that the internal temperature of the gel reached a predetermined temperature while measuring the internal temperature was used, and a predetermined drying time was applied to obtain an aerogel. Furthermore, a graph of the drying time vs the weight change was created, and the drying time was estimated from a value from the graph.

### Example 7

A porous body was produced by the same method as in Example 6, except that the drying temperature, the internal temperature of the gel, and the external temperature of the gel were changed to the values shown in Table 1 below.

### Example 8

A porous body was produced by the same method as in Example 1, except that the pressure in the drying treatment was changed to the value shown in Table 1 below.

### Example 9

A porous body was produced by the same method as in Example 6, except that the pressure in the drying treatment was changed to the value shown in Table 1 below.

### Comparative Example 1

A porous body was produced by the same method as in Example 1, except that the drying temperature, the internal temperature of the gel, and the external temperature of the gel were changed to the values shown in Table 1 below by leaving the gel to stand at room temperature (23° C.) instead of the drying treatment using the superheated steam dryer.

### Comparative Example 2

A porous body was produced by the same method as in Example 1, except that the drying temperature, the internal temperature of the gel, and the external temperature of the gel were changed to the values shown in Table 1 below by drying with hot air instead of the drying treatment using the superheated steam dryer.

### Comparative Example 3

A porous body was produced by the same method as in Example 1, except that the pressure in the drying treatment was changed to the value shown in Table 1 below.

### Comparative Example 4

A porous body was produced by the same method as in Example 6, except that the pressure in the drying treatment was changed to the value shown in Table 1 below.

### [Evaluation]

The results of the items shown below for the produced porous body are shown in Table 1 below.

### (1) Porosity

The volume of the porous body was measured with a caliper, the mass was measured with an electronic balance, and the porosity was calculated by the above-described method.

### (2) Thickness

The thickness of the porous body was measured with a caliper.

### (3) Transmittance

The porous body was set in a spectrophotometer (V-670, manufactured by JASCO Corporation), and the transmittance with respect to the wavelength was calculated.

TABLE 1

| | | | | | | Drying treatment | | | |
|---|---|---|---|---|---|---|---|---|---|
| | | Solvent 1 | | Solvent 2 | | | | | Internal |
| | | | Mass | | Mass | | | Drying | temperature |
| | | | ratio | | ratio | Drying | Pressure | temperature | of [symbol] |
| | | Type | (%) | Type | (%) | method | (Pa) | (° C.) | (° C.) |
| Example | 1 | Water | 100 | — | — | Superheated | [symbol] | 100 | 100 |
| | | | | | | steam drying | | | |
| Example | 2 | Water | 100 | — | — | Superheated | [symbol] | 100 | 100 |
| | | | | | | steam drying | | | |
| Example | 3 | Water | 100 | — | — | Superheated | [symbol] | 100 | 100 |
| | | | | | | steam drying | | | |
| Example | 4 | Water | 100 | — | — | Superheated | [symbol] | 140 | 140 |
| | | | | | | steam drying | | | |
| Example | 5 | Water | 90 | Ethanol | 10 | Superheated | [symbol] | 140 | 140 |
| | | | | | | steam drying | | | |
| Example | 6 | Water | 100 | — | — | Microwave | [symbol] | 140 | 140 |
| | | | | | | drying | | | |
| Example | 7 | Water | 100 | — | — | Microwave | [symbol] | [symbol] | [symbol] |
| | | | | | | drying | | | |
| Example | 8 | Water | 100 | — | — | Superheated | [symbol] | 100 | 100 |
| | | | | | | steam drying | | | |
| Example | 9 | Water | 100 | — | — | Microwave | [symbol] | 140 | 140 |
| | | | | | | drying | | | |
| Compar- | 1 | Water | 100 | — | — | Room | [symbol] | 25 | [symbol] |
| ative | | | | | | temperature | | | |
| Example | | | | | | | | | |
| Compar- | 2 | Water | 100 | — | — | Hot air | [symbol] | 140 | [symbol] |
| ative | | | | | | drying | | | |
| Example | | | | | | | | | |
| Compar- | 3 | Water | 100 | — | — | Superheated | [symbol] | 100 | 100 |
| ative | | | | | | steam drying | | | |
| Example | | | | | | | | | |
| Compar- | 4 | Water | 100 | — | — | Microwave | [symbol] | 140 | 140 |
| ative | | | | | | drying | | | |
| Example | | | | | | | | | |

| | Drying treatment | | | | | |
|---|---|---|---|---|---|---|
| | | Area of | Total area | | | |
| | External | [symbol] | of side | [symbol] porous body | | |
| | temperature | surface | surface | | Thick- | Trans- |
| | of [symbol] | part | parts | Porosity | ness | mittance |
| | (° C.) | ( [symbol] ) | ( [symbol] ) | (%) | (#Z;899;) | (%) |
| Example | 100 | 100 | 400 | 90 | 1 | [symbol] |
| Example | 100 | [symbol] | [symbol] | 91 | 2 | [symbol] |
| Example | 100 | 10,000 | 4,000 | 92 | 2 | [symbol] |
| Example | 140 | 10,000 | 4,000 | 93 | 1 | 87 |
| Example | 140 | 10,000 | 4,000 | 93 | 1 | [symbol] |
| Example | 100 | 10,000 | 4,000 | [symbol] | 2 | 70 |
| Example | 100 | 10,000 | 4,000 | [symbol] | 1 | 85 |
| Example | 100 | 100 | 400 | 90 | 1 | 87 |
| Example | 100 | 10,000 | 4,000 | [symbol] | 2 | [symbol] |
| Compar- | 25 | [symbol] | 400 | 40 | 1 | [symbol] |
| ative | | | | | | |
| Example | | | | | | |
| Compar- | 140 | 0 | 0 | [symbol] | 1 | [symbol] |
| ative | | | | | | |
| Example | | | | | | |
| Compar- | 100 | 100 | 400 | [symbol] | 1 | [symbol] |
| ative | | | | | | |
| Example | | | | | | |
| Compar- | 100 | 100 | 400 | 70 | 1 | [symbol] |
| ative | | | | | | |
| Example | | | | | | |

[symbol]

indicates data missing or illegible when filed

From the results shown in Table 1, it was found that in a case where the drying treatment for the structure body hydrogel is drying at room temperature, the obtained porous body has a low porosity and a low transmittance (Comparative Example 1).

In addition, it was found that in a case where the drying treatment for the structure body hydrogel is carried out such that the internal temperature of the gel is lower than the external temperature of the gel, the obtained porous body has a low porosity and a low transmittance (Comparative Example 2).

Moreover, it was found that in a case where the drying treatment for the structure body hydrogel is carried out at a pressure that does not satisfy 10² Pa or more and 10⁶ Pa or less, the obtained porous body has a low porosity and a low transmittance (Comparative Examples 3 and 4).

On the other hand, it was found that in a case where the drying treatment is carried out at a temperature equal to or higher than the boiling point of the solvent such that the internal temperature of the gel is equal to or higher than the external temperature of the gel, the obtained porous body has a high porosity, and the volume shrinkage during drying at a pressure of 10² Pa or more and 10⁶ Pa or less can be suppressed (Examples 1 to 9).

In particular, from the comparison of Examples 1 to 3, it was found that in a case where the shape of the structure body hydrogel is a polyhedron shape including a top surface part, a bottom surface part, and side surface parts, and the surface area of the top surface part is equal to or more than a total surface area of the side surface parts, the thickness as well as the porosity of the obtained porous body are increased, and thus, the volume shrinkage during drying at a pressure of 10² Pa or more and 10⁶ Pa or less is further suppressed.

What is claimed is:

1. A method for manufacturing a porous body, the method comprising:
subjecting a gel that has a solvent including water and a structure body with a three-dimensional mesh structure to a drying treatment to produce a porous body,
wherein the drying treatment is carried out at a pressure of 10² Pa or more and 10⁶ Pa or less and a temperature equal to or higher than a boiling point of the solvent such that an internal temperature of the gel is equal to or higher than an external temperature of the gel.

2. The method for manufacturing a porous body according to claim 1,
wherein the structure body with a three-dimensional mesh structure is a cellulose nanofiber.

3. The method for manufacturing a porous body according to claim 1,
wherein a temperature difference between the internal temperature of the gel and the external temperature of the gel is 50° C. or less.

4. The method for manufacturing a porous body according to claim 1,
wherein a shape of the gel is a three-dimensional shape which may have a curved surface, and
a surface area of one surface X is equal to or more than a total surface area of surfaces adjacent to the surface X.

5. The method for manufacturing a porous body according to claim 1,
wherein the drying treatment is a treatment of carrying out at least one of superheated steam drying or microwave drying.

6. A method for manufacturing a porous body, the method comprising:
subjecting a gel that has a solvent including water and a structure body with a three-dimensional mesh structure to a drying treatment to produce a porous body,
wherein the drying treatment is a treatment in which at least one of superheated steam drying or microwave drying is carried out at a pressure of 10² Pa or more and 10⁶ Pa or less and a temperature equal to or higher than a boiling point of the solvent.

7. The method for manufacturing a porous body according to claim 6,
wherein the structure body with a three-dimensional mesh structure is a cellulose nanofiber.

8. A porous body having a porosity of 80% or more, the porous body comprising:
a layered structure in a plane direction.

9. The porous body according to claim 8,
wherein an indentation fracture stress is 0.5 MPa or more.

10. The method for manufacturing a porous body according to claim 2,
wherein a temperature difference between the internal temperature of the gel and the external temperature of the gel is 50° C. or less.

11. The method for manufacturing a porous body according to claim 2,
wherein a shape of the gel is a three-dimensional shape which may have a curved surface, and
a surface area of one surface X is equal to or more than a total surface area of surfaces adjacent to the surface X.

12. The method for manufacturing a porous body according to claim 2,
wherein the drying treatment is a treatment of carrying out at least one of superheated steam drying or microwave drying.

13. The method for manufacturing a porous body according to claim 3,
wherein a shape of the gel is a three-dimensional shape which may have a curved surface, and
a surface area of one surface X is equal to or more than a total surface area of surfaces adjacent to the surface X.

14. The method for manufacturing a porous body according to claim 3,
wherein the drying treatment is a treatment of carrying out at least one of superheated steam drying or microwave drying.

15. The method for manufacturing a porous body according to claim 4,
wherein the drying treatment is a treatment of carrying out at least one of superheated steam drying or microwave drying.
